(19) United States
(12) Patent Application Publication
(10) Pub. No.: US 2004/0100865 A1
(43) Pub. Date: May 27, 2004

(54) Flexible offshore reservoir monitoring and seismic data acquisition

(76) Inventor: Stig Rune Lennart Tenghamn, Katy, TX (US)

Correspondence Address: E. EUGENE THIGPEN, PETROLEUM GEO-SERVICES, INC., P.O. BOX 42805, HOUSTON, TX, 77242-2805, US

(21) Appl. No.: 10/304,444

(22) Filed: Nov. 26, 2002

(51) Int. Cl. G01V 1/38; B64C 27/00

(52) U.S. Cl. 367/16

(57) ABSTRACT

In one embodiment the invention comprises a method for seismic data acquisition in which at least one conduit is installed on a sea floor and at least one seismic sensor is removably installed within said at least one conduit.

### BACKGROUND OF INVENTION

As the reservoirs in producing offshore wells deplete, the conditions affecting the production of these wells begin to change. Accurately monitoring the depletion rate of the underground reservoir allows the operator to optimize drilling and recovery. However, conventional monitoring techniques are expensive and the production of the reservoir may not be sufficient to support the monitoring cost.

Current techniques, such as vertical seismic profiling (VSP), intra-well seismic profiling, and inter-well seismic profiling, place receivers in existing wells. Because sensors are placed in existing wells, these techniques provide limited lateral coverage. Furthermore, because the techniques require installation of receivers in existing wells, they may interfere with the production of the reservoir, which is expensive.

Another method of monitoring well depletion and seismic data acquisition is permanent sea floor installation. Depending on the number of sensors installed, sea floor installation can give good lateral coverage and reasonable vertical resolution. This approach, despite producing good quality data, has seen limited use because permanently installing the instruments to monitor an entire petroleum reservoir is generally very expensive. Furthermore, once installed, the receivers are subjected to the rather harsh environment of the sea floor, and these harsh conditions decrease the system's reliability. Finally, once a sensor is installed permanently, the operator may use only those sensors in those locations for surveys.

Thus, there is a long-felt need for a method and system that is cost effective and gives the operator greater flexibility in the locations and uses of the sensors used to monitor the well.

### SUMMARY OF THE INVENTION

In one embodiment the invention comprises a method for seismic data acquisition in which at least one conduit is installed on a sea floor and at least one seismic sensor is removably installed within said at least one conduit.

### BRIEF DESCRIPTION OF THE FIGURES

FIG. 1 shows installing a plurality of conduits in accordance with present invention.

FIG. 2 shows installing sensors into a conduit in accordance with the present invention.

FIG. 3 shows installing sensors by moving a pipe pig with pressure in accordance with the present invention.

FIG. 4 shows installing sensors by moving a tractor in accordance with the present invention.

FIG. 5 shows taking a seismic reading with sensors installed in a conduit in accordance with the present invention.

FIG. 6 shows using a remotely operated vehicle to install sensors into a conduit in accordance with the present invention.

FIG. 7 shows a plurality of conduits accessible from land in accordance with the present invention.

FIG. 8 shows a track conduit in accordance with the present invention.

### DESCRIPTION OF PREFERRED EMBODIMENTS OF THE INVENTION

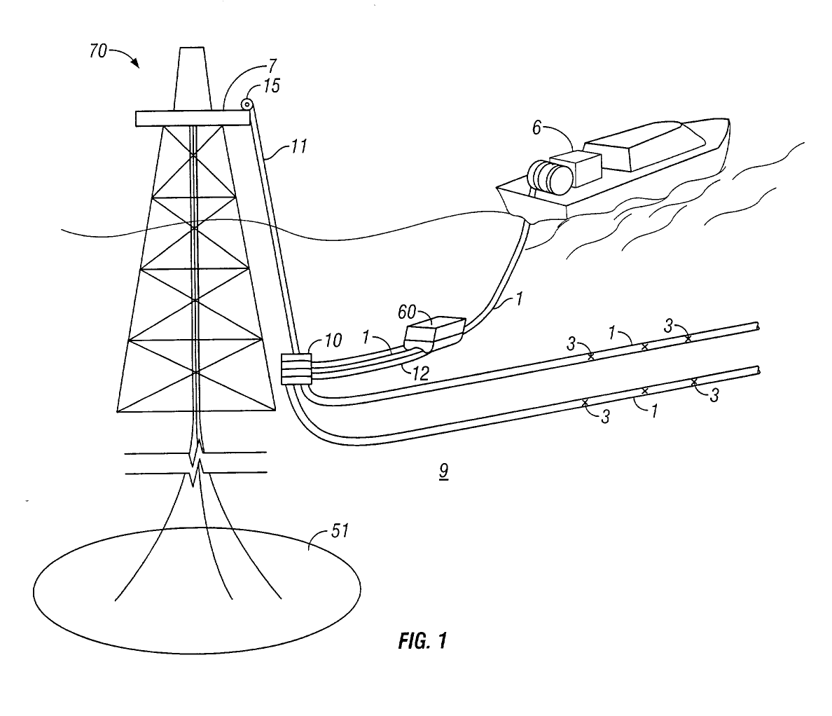

In one embodiment of the present invention, a method and system are provided that provide flexibility in seismic data acquisition and reservoir monitoring. FIG. 1 illustrates an offshore platform 70 above a producing reservoir 51, which, typically, is in the early stages of production. Rather than making the expensive initial investment of permanently installing sensors around the reservoir 51 for monitoring, possible sensor locations around the reservoir 51 are determined. The operator will consider many factors in determining where the receivers may be beneficial in future surveys such as the stage of development, the location of the platform, any neighboring reservoirs, or any other factor that will occur to those of ordinary skill.

Once it is determined where it may be desirable to install sensors, a plurality of conduits 1 is installed to these possible sensor locations 3. FIG. 1 shows two conduits 1 installed on the sea floor, and a third conduit 1 being rolled out from behind a vessel 6. In the illustrated embodiment, for good coupling with the earth, a cable trench machine 60 prepares the floor 9 for the installation of the conduit 1 by trenching the floor 9 while the conduit 1 is rolled out. The conduit 1 is inserted inside the trench 12 and then buried. Burying the conduit 1 provides good coupling between the conduit 1 and the sea floor 9, and improves the impedance match between the sensors deployed in the conduit 1 and the surrounding environment.

In the illustrated embodiment, a single vertical conduit 11 extends from the deck 7 of a platform 70 down to a manifold unit 10. The vertical conduit 11 has an access location 15 at the deck 7 of the platform 70. The manifold unit 10 connects the vertical conduit 11 to the plurality of horizontal conduits 1 configured in a desired pattern on the floor 9. In this way, a large horizontal coverage of the field is accessible from a single access location 15 on the deck 7.

Once the conduits 1 and 11 are installed, the operator has great flexibility in determining which type of survey and coverage are necessary at that time. For example, for the initial survey, the operator may not want to invest in a large survey. Thus, some conduits 1 may not be used for the performance of a survey. In the illustrated embodiment, the operator may determine that only one conduit 1 will be used.

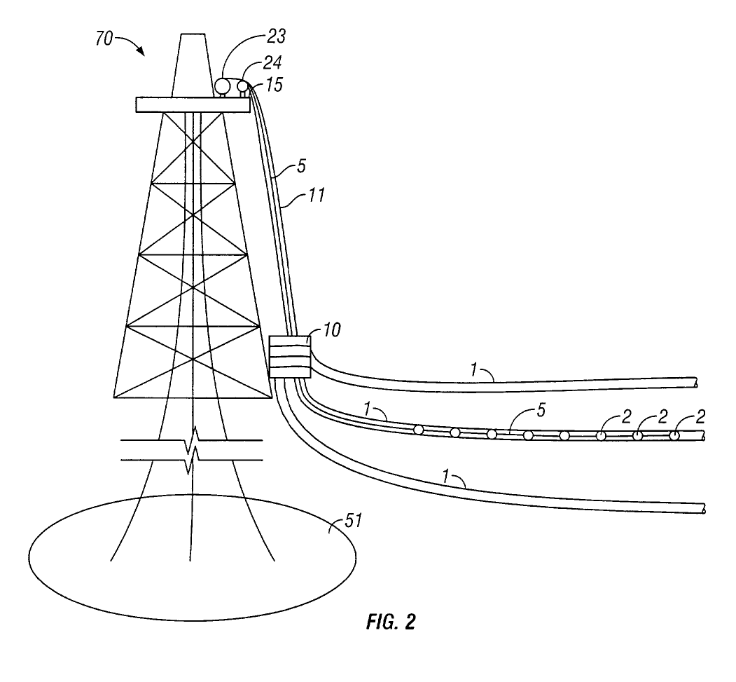

As shown in FIG. 2, sensors 2 are inserted into the vertical conduit 11, pushed down through the vertical conduit 11 and into the manifold unit 10. Once in the manifold unit 10, the sensors 2 are guided into the desired single horizontal conduit 1. Typically, conventional sensors 2 are secured within a cable 5 and are placed within the conduit 11 at the access point 15. FIG. 2 shows the cable 5 being inserted into conduit 11 by means of winch 23 and pulley 24.

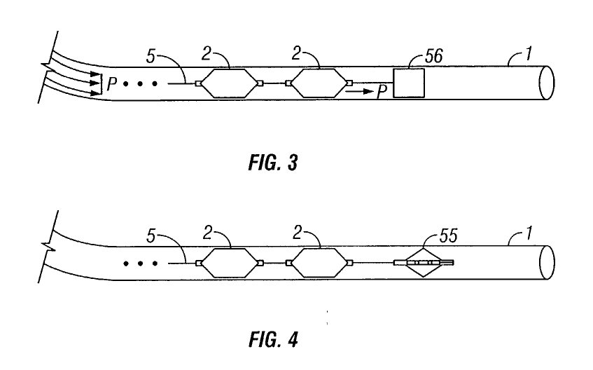

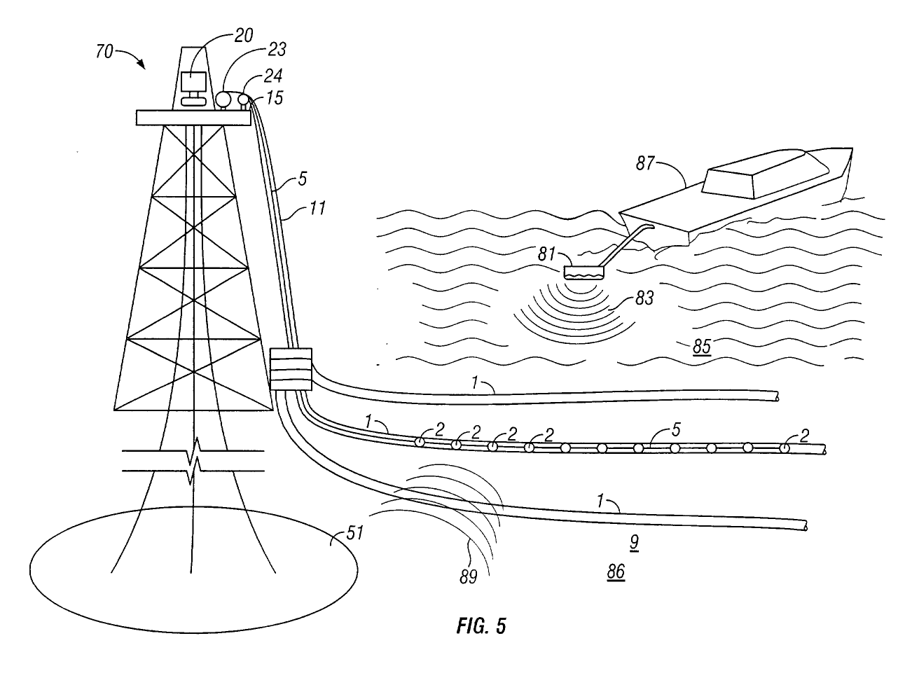

Various methods and instruments may be utilized to guide the sensors 2 to their desired locations in the conduit 1. FIG. 3 illustrates a pipe pig 56 being used to guide the sensors 2 to their desired locations within the conduits 1. The pig 56, which may be a conventional pipe pig, creates a blockage in the conduit 1 and pressure P, which may be hydraulic or pneumatic pressure, may be used to force the pig 56 through the conduit 1. The pig 56 then pulls the sensors 2 to the desired locations. FIG. 4 illustrates that in an alternate embodiment, a conventional tractor 55 may be used to pull the sensors 2 to their desired locations. Such tractors are known to those of ordinary skill in the art, without further elaboration. One example of such a tractor 55 is the Translog Tractor System available from Read Matre Instruments.

Various positioning systems, known to those of ordinary skill in the art, may be utilized for determining the locations of the sensors 2 within the conduit 1. For example, acoustic pingers are available for locating pigs in subsea fluid filled lines, and electromagnetic systems are available for pig location in gas filled lines from Nautronix Ltd., Nautronix House, Howe Moss Avenue, Kirkhill, Kyce, Aberdeen AB21 OGP, Scotland, or Nautronix Inc., 6611 Portwest, Suite 120, Houston, Tex. 77024.

FIG. 5 shows the sensors 2 inserted in only one of the conduits 1. Thus, in this example, a low cost initial survey is taken. However, with a plurality of conduits 1 in position on the sea floor, the operator then has the capability of performing a more extensive survey with greater lateral coverage, if desired, by inserting sensors 2 in a greater number of conduits 1. The type of sensors may also be changed in subsequent surveys. For example, geophones, or other particle motion sensors, may be used rather than pressure gradient sensors (such as hydrophones). Dual sensor surveys may also be performed in which a pressure gradient sensor is associated with each particle motion sensor. Dual sensor surveys can improve signal quality, for example, by enabling attenuation of the surface ghost signal by methods well known to those of ordinary skill in the art. Four-component sensors, which include a pressure gradient sensor (typically, a hydrophone) and three particle motion sensors (normally geophones) that sense motion in three orthogonal directions may also be utilized, Accordingly, the number of sensors deployed and the expense of the survey may be controlled by the operator, allowing flexible use of the method and system by an operator.

Once a survey has been performed, the operator may desire to remove the sensors 2 from the conduits 1. By removing the sensors 2, the sensors 2 are available for use on other jobs, and not subjected continuously to the harsh ocean bottom conditions. The sensors may be removed by pulling out the cable 5 using the winch 23 and pulley 24 shown in FIG. 2.

In a further example, time lapse surveys may be performed, either by leaving the sensors 2 in position during the time interval between survey repetitions, or by noting the locations of the sensors prior to removal and returning the sensors to the same locations, and repeating the survey.

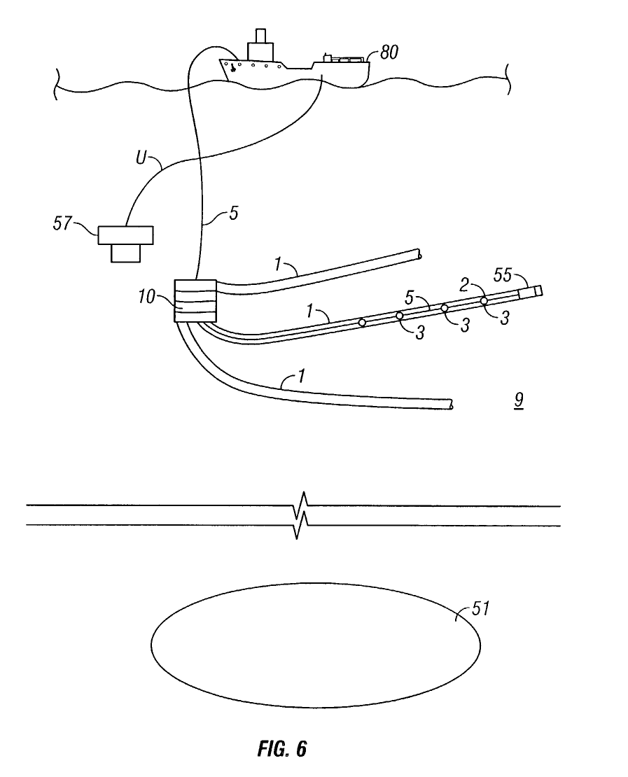

While the embodiments described above include a vertical conduit 11 extending from a platform 70, in alternate embodiments, a pattern of conduits 1 is accessed from a vessel. For example, in FIG. 6, a plurality of conduits 1 are shown installed on the sea floor 9 over a reservoir 51, with the entrance to each of the conduits 21 being through manifold unit 10. A remotely operated vehicle (ROV) 57 is utilized to gain access to the conduits 1. Such ROVs 57, which are known to those of ordinary skill in the art without further elaboration, are controlled from vessel 80 by means of signals transmitted through umbilical U. The ROV 57 inserts a cable 5, which includes the sensors 2, into the manifold unit 10, and from the manifold unit 10, a cable 5 is channeled into a specific conduit 1. Typically, a tractor 55 will be attached to the leading end of the cable 5. The tractor 55 is controlled from the vessel 80 and pulls the cable 5, with sensors 2 included therein, to the desired location with a conduit 1. The embodiment of FIG. 6 is especially well suited for seismic data acquisition in an area prior to installation of a platform.

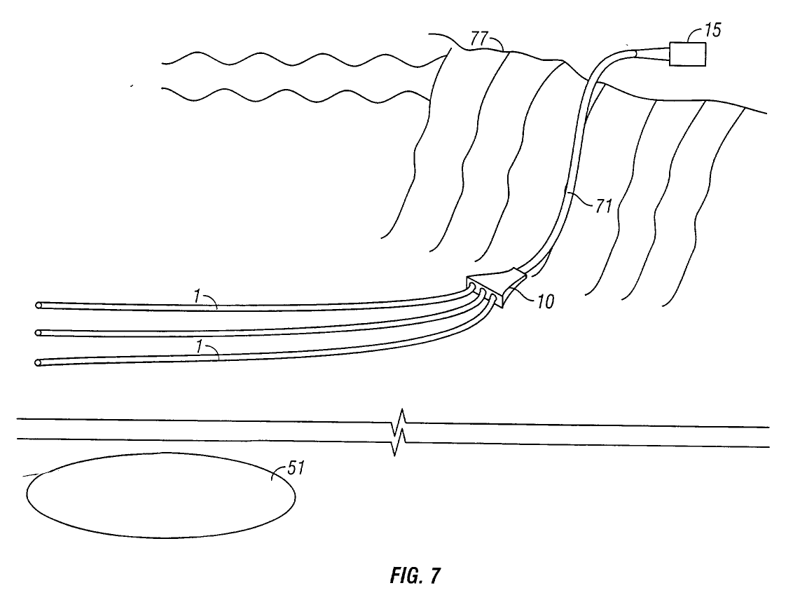

FIG. 7 shows yet another embodiment of the invention in which the conduits 1 are accessed from a land location. A single conduit 71 is shown with an access location 15 on the land 77. The conduit 71 is attached to manifold unit 10, which provides access to multiple conduits distributed on the sea floor. Except that the access location 15 is on land rather than on a platform, the operation of the embodiment described with reference to FIG. 7 is substantially the same as described with referenced to FIGS. 1 and 2.

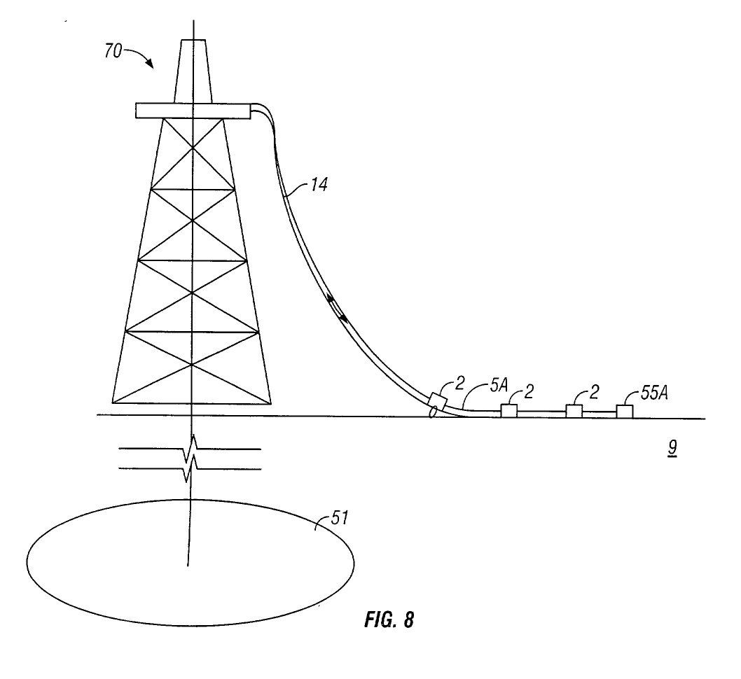

In the embodiments described with reference to FIGS. 1-7, the conduits 1 comprise a hollow tube of sufficient diameter to accommodate a cable including sensors therein. The conduits may be flexible or rigid, modular or singular, and may be made from various materials (e.g., steel, plastics or composites) that will occur to those of ordinary skill that are capable of withstanding the harsh water bottom conditions. With reference to FIG. 8, in a further embodiment, the conduit for conveying the sensors 2 to the desired sea floor location comprises a track 14, rather than the tubes described with respect to other embodiments. In alternative implementations track 14 may be rigid or flexible, modular or singular, and may be formed from various materials that will occur to those of ordinary skill that are capable of withstanding the harsh water bottom conditions (e.g. steel, plastics or composites). Typically, the sensors 2 are attached to a connecting cable 5A, and the sensors are secured to the track 14 by means of clasps, grooves or other means. A tractor 55A is secured to the leading end of cable 5A and is utilized for pulling the cable 5A along the track 14, until the sensors 2 are in the desired locations.

Once the sensors 2 are in the desired locations, a survey may be performed. FIG. 5 illustrates a seismic source boat 87 towing a seismic source 81. The source 81 creates an acoustic wave 83, which travels through the water 85 into the earth 86 and will reflect from subsurface reflecting interfaces, including interfaces within reservoir 51. The reflected wave 89 is then detected by the receivers 2, which generate an output signal (not illustrated) that is recorded on a storage medium 20. Storage medium 20 is typically a magnetic or optical storage medium that is a part of or under the control of a digital computer. As discussed previously, burying the conduits 1 improves the coupling of the conduit 1 with the sea floor 9, and thus, improves the coupling of the sensors 2 within the conduits 1 and to the sea floor 9.

Following recording of the survey on the recording medium 20, various data processing procedures, known to those of ordinary skill in the art, may be performed on the data. For example, the data may be deconvolved, summed, migrated, move-out corrected or processed in other ways known to those of ordinary skill. The processed data are then available to image the reservoir in any manner known to those of ordinary skill in the art.

The invention has been described with a certain degree of particularity, however, many changes may be made in the details without departing from the scope of the invention. It is understood that the invention is not limited to the embodiments set forth herein, but is to be limited only to the scope of the attached claims, including the full range of equivalency to which each element thereof is entitled.

I claim:

1. A method for seismic data acquisition, comprising:
installing at least one conduit on a sea floor; and
removably installing at least one seismic sensor within said at least one conduit.

2. The method of claim 1 further comprising performing a seismic survey, and removing said at least one seismic sensor from said at least one conduit following completion of said survey

3. The method of claim 2 further comprising reinstalling at least one seismic sensor within said at least one conduit and performing a subsequent seismic survey.

4. A method of claim 1 wherein the act of installing at least one conduit on a sea floor comprises installing a plurality of conduits on a sea floor and the act of removably installing at least one sensor comprises removably installing at least one seismic sensor in each of a plurality or said conduits.

5. The method of claim 4 wherein said conduits are installed in a selected pattern on said sea floor.

6. The method of claim 1 wherein said at least one conduit is installed on a sea floor from a vessel.

7. The method of claim 1 wherein said at least one conduit is installed on a sea floor from an offshore platform.

8. The method of claim 1 wherein installing said at least one conduit comprises digging a trench in said sea floor, inserting a said conduit into said trench, and burying said conduit.

9. A method for seismic data acquisition in a marine location, comprising:
extending a first conduit from a location above a sea surface to substantially a sea floor, a first end of said first conduit being at said location above the sea surface and a second end of said first conduit being at substantially a sea floor;
connecting said second end of said first conduit to an inlet of a manifold;
installing a plurality of second conduits on said sea floor and connecting a first end of each of said second conduits to outlets of said manifold; and
wherein said first conduit and said second conduits are adapted to receive seismic sensors therein.

10. The method of claim 8 further comprising removably transporting seismic sensors by means of said first conduit, through said manifold into at least one of said second conduits.

11. The method of claim 10 wherein at least one tractor is utilized for transporting said seismic sensors.

12. The method of claim 10 wherein at least one pipe pig is utilized for transporting said seismic sensors. 13. The method of claim 10 further comprising utilizing a winch to remove said sensors from said first and second conduits.

14. The method of claim 10 wherein said first conduit comprises a tube. 15. The method of claim 10 wherein said first conduit comprises a track.

16. A system for seismic data acquisition, comprising:
at least one conduit installed on a sea floor; and
at least one seismic sensor removably installed within said at least one conduit.

17 The system of claim 16 wherein said at least one conduit installed on a sea floor comprises a plurality of conduits installed on a sea floor and said at least one sensor comprises at least one seismic sensor removably installed in each of a plurality or said conduits.

18. The system of claim 17 wherein said conduits are installed in a selected pattern on said sea floor.

19. The system of claim 16 wherein said at least one conduit is buried in the sea floor.

20. A system for seismic data acquisition in a marine location, comprising:
a first conduit extending from a location above a sea surface to substantially a sea floor, a first end of said first conduit being at said location above the sea surface and a second end of said first conduit being at substantially a sea floor;
a manifold having an inlet connected to a second end of said first conduit;
a plurality of second conduits installed on said sea floor, a first end of each of said second conduits being connected to outlets of said manifold; and
wherein said first conduit and said second conduits are adapted to receive seismic sensors therein.

21. The system of claim 20 further comprising seismic sensors removably positioned in said first conduit, through said manifold into at least one of said second conduits.

22. The system of claim 21 further comprising a tractor utilizable for transporting said seismic sensors into a second conduit.

23. The system of claim 21 further comprising a pipe pig utilizable for transporting said seismic sensors into a second conduit.

24. The system of claim 21 further comprising a winch utilizable for removing said sensors from said first and second conduits.

25. The system of claim 21 wherein said first conduit comprises a tube.

26. The method of claim 21 wherein said first conduit comprises a track.

27. A system for positioning a plurality of seismic sensors on the floor of a body of water, the system comprises:
an access point;
a conduit extending from the access point to a plurality of sensor locations on the floor of the body of water; and
a means for moving the sensors from the access point to the plurality of sensor locations with the conduit.

28. The system of claim 27, wherein the conduit comprises a tube.

29. The system of claim 27, wherein the conduit comprises a track.

30. The system of claim 27, wherein the means for moving comprises means for moving the sensor within the conduit.

31. The system of claim 27 wherein the means for moving comprises a winch.

32. The system of claim 27, wherein the means for moving comprises a pipe pig.

33. The system of claim 27, wherein the means for moving comprises a tractor.

34. The system of claim 27, further comprising
a plurality of conduits; and
a manifold unit;
wherein the manifold unit connects at least two conduits.

35. The system of claim 34, comprising a vertical conduit and a horizontal conduit.

36. The system of claim 27, wherein the access point comprises a location on a platform.

37. The system of claim 27, wherein the access point comprises a location on a vessel.

38. The system of claim 27, wherein the access point is on the floor of the body of water.

39. The system of claim 27, wherein the access point comprises a location on land.

40. The system of claim 27, wherein the conduit comprises steel.

41. The system of claim 27, wherein the conduit comprises plastic.

42. The system of claim 27, wherein the conduit comprises a composite.
